(19) United States
(12) Patent Application Publication
(10) Pub. No.: US 2025/0275884 A1
(43) Pub. Date: Sep. 4, 2025

(54) ELECTROMAGNETICALY DRIVEN CHASSIS ASSEMBLY AND RHYTHMIC FURNITURE

(71) Applicant: SHENZHEN FAR EXCEEDS SMART LIFE CO., LTD, Shenzhen (CN)

(72) Inventors: Shuhan CAO, Shenzhen (CN); Meiping CHEN, Shenzhen (CN)

(73) Assignee: SHENZHEN FAR EXCEEDS SMART LIFE CO., LTD, Shenzhen (CN)

(21) Appl. No.: 19/210,215

(22) Filed: May 16, 2025

Related U.S. Application Data
(63) Continuation of application No. PCT/CN2024/081659, filed on Mar. 14, 2024.

(30) Foreign Application Priority Data
Feb. 7, 2024 (CN) 202410174473.7

(51) Int. Cl. A61H 23/02

(52) U.S. Cl. CPC A61H 23/0218; A61H 2201/0138; A61H 2201/123

(57) ABSTRACT

An electromagnetic driven chassis assembly includes a first frame body, a second frame body, a guide mechanism, and an electromagnetic driving mechanism. The electromagnetic driving mechanism includes a coil unit and a magnetic module, with a magnetic force generated between the coil unit and the magnetic module through magnetic field changes to enable relative movement between the first frame body and the second frame body. The coil unit is provided with a motion channel, and the magnetic module includes a transmission shaft and two magnets. The end of the transmission shaft is connected to the second frame body, and the transmission shaft is movably inserted into the motion channel. The two magnets are mounted on the transmission shaft, with their respective magnetic poles being identical at the opposing ends. Changing the direction of the current simultaneously alters the interaction between the two magnets and the coil unit.

### CROSS-REFERENCE TO RELATED APPLICATIONS

This application is a continuation of International Patent Application No. PCT/CN2024/081659 with a filing date of Mar. 14, 2024, designating the United States, now pending, and further claims priority to Chinese Patent Application No. 202410174473.7 with a filing date of Feb. 7, 2024. The content of the aforementioned applications, including any intervening amendments thereto, are incorporated herein by reference.

### TECHNICAL FIELD

The disclosure relates to the technical field of furniture, and more specifically, to an electromagnetically driven chassis assembly and rhythmic furniture.

### BACKGROUND OF THE INVENTION

With the continuous progress of society, people's quality of life has been consistently enhanced. Rhythmic furniture has become an essential household item for leisure, contributing to an improved quality of life through its back-and-forth reciprocating motion.

In conventional rhythmic furniture, a driving mechanism is arranged between a first frame body and a second frame body which move relatively, and the driving mechanism is usually driven by a magnetomotive driving mode. In the related art, the patent with publication number CN219148428U discloses a novel massage armchair vibration chassis structure. Specifically, the actuating mechanism includes a coil and a magnet, with one side of the coil positioned adjacent to the magnet, and movement is driven by the variation in the magnetic field between the coil and the magnet. However, the above-described driving structure has the following issues: when the magnet and coil are too close, collisions are likely to occur; conversely, when the magnet and coil are too far apart, insufficient magnetic force may result.

### BRIEF SUMMARY OF THE INVENTION

The disclosure provides an electromagnetically driven chassis assembly designed to address the problem in the prior art where the components of the driving mechanism experience collisions or insufficient magnetic force when driven magnetically.

The present disclosure provides an electromagnetically driven chassis assembly, comprising:
a first frame body
a second frame body, wherein the second frame body and the first frame body are configured to move relative to each other;
a guide mechanism disposed between the first frame body and the second frame body, the guide mechanism being configured to guide relative movement between the first frame body and the second frame body; and
an electromagnetic driving mechanism, wherein the electromagnetic driving mechanism comprising a coil unit and a magnetic unit, the first frame body being connected to the coil unit, the second frame body being connected to the magnetic unit, and magnetic force being generated between the coil unit and the magnetic unit through changes in the magnetic field to enable relative movement between the first frame body and the second frame body;
wherein the coil unit is provided with a motion channel, the magnetic unit comprising a transmission shaft and two magnets, an end portion of the transmission shaft is connected to the second frame body, the transmission shaft movably extends through the motion channel, the two magnets are disposed on the transmission shaft, the two magnets each extend at least partially into the motion channel, and the magnetic poles at opposite ends of the two magnets are identical.

According to the electromagnetically driven chassis assembly provided by the disclosure, a gap denoted as L, is provided between the two magnets (422), with L ranging from 2 mm to 10 mm.

According to the electromagnetically driven chassis assembly provided by the disclosure, the magnetic unit comprising a separation sheet, the separation sheet being disposed between the two magnets, wherein one end of the separation sheet abuts against one of the magnets, and another end of the separation sheet abuts against other one of the two magnets.

According to the electromagnetically driven chassis assembly provided by the disclosure, the magnetic unit further comprising a positioning structure disposed on the transmission shaft, and the positioning structure being configured to restrict the movement of the two magnets along an axis of the transmission shaft.

According to the disclosure, an electromagnetically driven chassis assembly is provided, wherein the positioning structure comprising:
two positioning washers sleeved onto the transmission shaft, with the two magnets positioned between the two positioning washers, and each of the two positioning washers is in a one-to-one abutting connection with a corresponding magnet;
two positioning components fixedly connected to the transmission shaft, wherein each of the two positioning components is in a one-to-one abutting fit with a corresponding positioning washer, thereby restricting movement of the positioning washers relative to the axis of the transmission shaft.

According to the electromagnetically driven chassis assembly provided by the disclosure, wherein connecting plates are disposed at both ends of the second frame body corresponding to the transmission shafts, the connecting plates being provided with connecting channels including openings, and ends of the transmission shafts are configured to move along the openings and engage in a plug-in fit with the connecting channels;
wherein a fastening assembly is provided between each end of the transmission shaft and each of the connecting plates, and the fastening assembly being configured to secure the transmission shaft to the connecting plates.

According to the electromagnetically driven chassis assembly provided by the disclosure, wherein the fastening assembly comprising a first fastener, a second fastener, and a limiting plate, the first fastener and the second fastener being positioned on opposite sides of each of the connecting plate and each being fixedly connected to an end of the transmission shaft; wherein the limiting plate is sleeved onto the end of the transmission shaft, fixedly connected to the connecting plate, and has an outer diameter larger than an inner diameter of each of the connecting channels;
wherein the first fastener is positioned on a side of each of the connecting plate facing away from a middle of the magnetic unit, and the limiting plate is located between the first fastener and one of the connecting plates and abuts against the first fastener, the second fastener, and the one of the connecting plates.

According to the electromagnetically driven chassis assembly provided by the disclosure, wherein the coil unit comprising:
a mounting frame body, wherein the mounting frame body is connected to the first frame body, and a motion channel is formed in the mounting frame body; and
a coil body, wherein the coil body is mounted on the mounting frame body.

According to the electromagnetically driven chassis assembly provided by the disclosure, the mounting frame body is a stainless-steel profiled frame.

According to the electromagnetically driven chassis assembly provided by the disclosure, wherein multiple sets of electromagnetic driving mechanisms are provided, and the multiple sets of electromagnets driving mechanisms are arranged at intervals between the first frame body and the second frame body.

According to the electromagnetically driven chassis assembly provided by the disclosure, wherein the guide mechanism comprising:
a guide elastic plate;
a first fixing unit comprising: a first fixing member, a first pressing piece, and a first connecting structure, wherein one end of the guide elastic plate is clamped between the first fixing member and the first pressing piece, and the first fixing member, the first pressing piece, and one end of the guide elastic plate are fixedly connected to the first frame body through the first connecting structure; and
a second fixing unit comprising: a second fixing member, a second pressing piece, and a second connecting structure, wherein the other end of the guide elastic plate is clamped between the second fixing member and the second pressing piece, and the second fixing member, the second pressing piece, and the other end of the guide elastic plate are fixedly connected to the second frame body through the second connecting structure;
wherein the first fixing member is provided with a first limiting concave surface, and the second fixing member is provided with a second limiting concave surface, wherein widths of the first limiting concave surface and the second limiting concave surface are matched with a width of the guide elastic plate.

According to the electromagnetically driven chassis assembly provided by the disclosure, wherein opposite ends of the first frame body are provided with first magnetic modules, opposite ends of the second frame body are provided with second magnetic modules, and the first magnetic modules and the second magnetic modules are arranged in a one-to-one correspondence and at intervals;
wherein poles at the opposite ends of the first magnetic module and the second magnetic module are identical.

The disclosure further provides a rhythmic furniture, comprising the electromagnetic driving chassis assembly as described above.

The electromagnetic driving chassis assembly provided by the present disclosure generates magnetic force between the magnetic unit and the coil unit through a magnetic field change when the coil unit is energized. Since the coil unit is connected to the first frame body and the magnetic unit is connected to the second frame body, the magnetic field will affect the second frame body, thereby causing relative movement between the first and second frame bodies along the guide mechanism through the magnetic force;
the coil unit is provided with a motion channel, which is designed to accommodate the movement of the magnet and the transmission shaft, allowing the magnetic unit to move freely within the motion channel without being fixed or restricted; Due to the clearance gap between the outer wall of the magnetic unit and the inner wall of the motion channel, this gap ensures that the magnetic unit move smoothly within the motion channel; this also helps to prevent collisions between the coil unit and the magnetic unit, and avoids friction or jamming issues; in a stationary state, at least part of the structure of the two magnets extends into the motion channel, this means that when the magnets are at a certain position within the motion channel and are not moving, the projection of the structure between the motion channel and the magnets will partially overlap. This overlap indicates that there is still some overlap between the coil unit and the magnets. As a result, when transitioning from the stationary state to the moving state, the magnetic field between the coil unit and the magnetic unit can change quickly; In the moving state, when the magnetic unit moves within the motion channel, the degree of overlap between the projection of the motion channel and the magnet will change. However, the projections of both the motion channel and the magnet will still overlap, maintaining a physical connection and interaction between the two. This ensures that the coil unit and the magnetic unit remain in a good working condition, allowing the magnetic force to be effectively transmitted to the coil. Consequently, sufficient magnetic force is generated to drive the relative movement between the first and second frame bodies, allowing the electromagnetic drive mechanism to effectively achieve the relative movement of the first and second frame bodies;

Under the condition that the magnetic poles at the opposite ends of the two magnets are identical (i.e., both the N-pole or both the S-pole), the direction of the current in the coil unit can be adjusted to control whether the magnetic field generated by the coil unit attracts or repels one end of the magnet. The resulting attraction or repulsion can drive the transmission shaft to move along the motion channel. Since the magnetic poles at the opposite ends of the two magnets are identical, changing the direction of the current alters the nature of the interaction between the two magnets and the coil unit (from attraction to repulsion, or from repulsion to attraction), thereby controlling the direction of movement of the transmission shaft. By leveraging the principle of electromagnetic induction, high-precision motion control of the transmission mechanism can be achieved. The intensity of the magnetic field generated by the coil unit can be regulated by adjusting the current strength, which in turn controls the attraction or repulsive force applied to the magnet. This further reduces mechanical wear, improves the reliability and service life of the electromagnetically driven mechanism, and makes the electromagnetic transmission system suitable for various applications requiring precise control.

### BRIEF DESCRIPTION OF THE DRAWINGS

In order to more clearly illustrate the technical solutions in the present disclosure or prior art, the following is a brief description of the drawings required for the embodiments or prior art. It is apparent that the drawings described below are part of the embodiments of the present disclosure. For those skilled in the art, without any creative effort, other drawings can also be derived from these drawings.

FIG. 1 is a schematic diagram of the structure of the electromagnetic driving chassis assembly provided by the present disclosure;

FIG. 2 is a schematic diagram showing the mating structure of the first frame body, second frame body, and electromagnetic driving mechanism of the electromagnetic driving chassis assembly provided by the present disclosure;

FIG. 3 is an exploded view of FIG. 2;

FIG. 4 is a cross-sectional view of FIG. 2;

FIG. 5 is a schematic diagram of the structure of the guide mechanism provided by the present disclosure;

FIG. 6 is a schematic diagram of the structure of the first magnetic module and second magnetic module provided by the present disclosure;

FIG. 7 is a simplified structural diagram of the electromagnetic driving mechanism provided by the present disclosure;

### REFERENCE NUMBERS

100, First frame body; 110, Bottom plate; 200, Second frame body; 210, Connecting plate; 211, Connecting channel;
300, Guide mechanism; 310, Guide elastic plate; 321, First fixing member; 3211, First limiting concave surface; 322, First pressing piece; 331, Second fixing member; 332, Second pressing piece; 3311, Second limiting concave surface;
400, Electromagnetic driving mechanism; 410, Coil unit; 411, motion channel; 412, Mounting frame body; 4121, Supporting side plate; 4122, Supporting tube; 413, Coil body; 414, Protective cover; 420, Magnetic module; 421, Transmission shaft; 422, Magnet; 423, Separation sheet; 424, Positioning washer; 425, Positioning component;
510, First fastener; 520, Second fastener; 530, Limiting plate;
610, First magnetic module; 611, First mounting plate; 612, First magnetic column; 613, First pad piece; 620, Second magnetic module; 621, Second mounting plate; 622, Second magnetic column; 623, Second pad piece.

### DETAILED DESCRIPTION OF PREFERRED EMBODIMENTS

In order to make the objectives, technical solutions, and advantages of the present disclosure clearer, the following detailed description of the technical solutions of the present disclosure will be provided in conjunction with the accompanying drawings. It is evident that the described embodiments are part of the embodiments of the present disclosure, rather than all the embodiments. Based on the embodiments of the present disclosure, all other embodiments that can be derived by those skilled in the art without requiring inventive effort are within the scope of protection of the present disclosure.

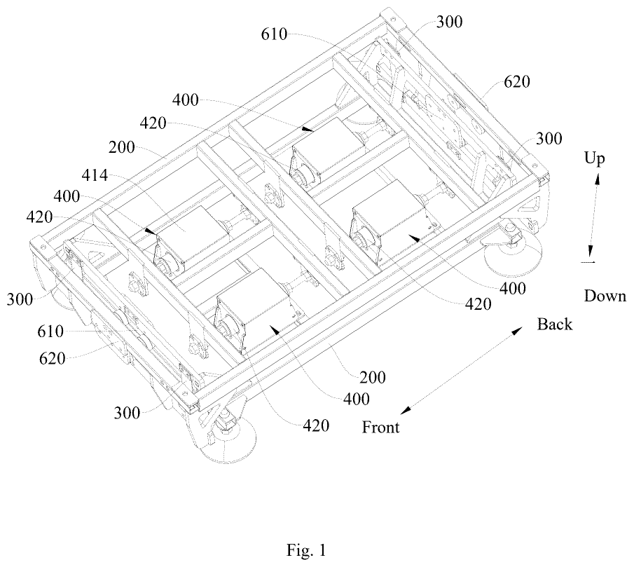

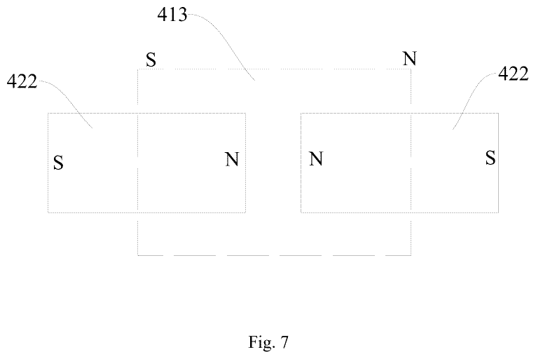

The electromagnetic driven chassis assembly and rhythmic furniture of the present disclosure are described below in conjunction with FIG. 1-FIG. 7. The rhythmic furniture includes a massage body that bears the user and an electromagnetic driving chassis assembly disposed at the bottom of the massage body. It should be noted that in some embodiments of the present disclosure, the rhythmic furniture is a rhythmic chair, with the electromagnetic driven chassis assembly located at the bottom of the rhythmic chair. Of course, in other embodiments, the electromagnetic driving chassis assembly may also be applied to other types of rhythmic furniture, such as rhythmic sofas, rhythmic beds, and so on.

Referring to FIGS. 1 to 4 and FIG. 7, the present disclosure provides an electromagnetic driven chassis assembly, including a first frame body 100, a second frame body 200, a guide mechanism 300, and an electromagnetic driving mechanism 400. The second frame body 200 and the first frame body 100 are capable of relative movement. The guide mechanism 300 is provided between the first frame body 100 and the second frame body 200 and is used to guide the relative movement of the first frame body 100 and the second frame body 200. The electromagnetic driving mechanism 400 includes a coil unit 410 and a magnetic module 420. The first frame body 100 is connected to the coil unit 410, and the second frame body 200 is connected to the magnetic module 420. A magnetic force is generated between the coil unit 410 and the magnetic module 420 through the magnetic field change to cause the relative movement between the first frame body 100 and the second frame body 200. The coil unit 410 is provided with a motion channel 411. The magnetic module 420 includes a transmission shaft 421 and two magnets 422. The end of the transmission shaft 421 is connected to the second frame body 200, and the transmission shaft 421 is movably disposed within the motion channel 411. The two magnets 422 are mounted on the transmission shaft 421, with at least part of the structure of the two magnets 422 extending into the motion channel 411, and the magnetic poles at the opposite ends of the two magnets 422 are identical.

The electromagnetic driven chassis assembly provided by the present disclosure generates magnetic force between the magnetic module 420 and the coil unit 410 through a change in the magnetic field when current is applied to the coil unit 410. Since the coil unit 410 is connected to the first frame body 100 and the magnetic module 420 is connected to the second frame body 200, the magnetic field affects the second frame body 200, thereby causing relative movement between the first frame body 100 and the second frame body 200 along the guide mechanism 300 through the magnetic force;
the coil unit 410 is provided with a motion channel 411, which is designed to accommodate the movement of the magnet 422 and the transmission shaft 421, allowing the magnetic module 420 to move freely within the motion channel 411 without being fixed or restricted; Due to the clearance gap between the outer wall of the magnetic module 420 and the inner wall of the motion channel 411, this gap ensures that the magnetic module 420 move smoothly within the motion channel 411; this also helps to prevent collisions between the coil unit 410 and the magnetic module 420, and avoids friction or jamming issues; in a stationary state, at least part of the structure of the two magnets 422 extends into the motion channel 411, this means that when the magnets 422 are at a certain position within the motion channel 411 and are not moving, the projection of the structure between the motion channel 411 and the magnets 422 will partially overlap. This overlap indicates that there is still some overlap between the coil unit 410 and the magnets 422. As a result, when transitioning from the stationary state to the moving state, the magnetic field between the coil unit 410 and the magnetic module 420 can quickly change; In the moving state, when the magnetic module 420 moves within the motion channel 411, the degree of overlap of the orthogonal projections between the motion channel 411 and the magnet 422 changes. However, the orthogonal projections of the two still overlap, and there remains a physical connection and interaction between them. This ensures a good working state between the coil unit 410 and the magnetic module 420, allowing magnetic force to be effectively transmitted to the coil, generating sufficient magnetic power to drive the relative movement between the first frame body 100 and the second frame body 200, enabling the electromagnetic drive mechanism 400 to effectively realize the relative movement between the first frame body 100 and the second frame body 200;

Since the magnetic poles at the opposite ends of the two magnets 422 are identical (i.e., both are N-poles or both are S-poles), by changing the direction of the current in the coil unit 410, the magnetic field generated by the coil unit 410 can be controlled to either attract or repel one end of the magnet 422. This attractive or repulsive force can drive the transmission shaft 421 to move along the motion channel 411. Because the magnetic poles at the opposite ends of the two magnets 422 are identical, changing the direction of the current will simultaneously alter the nature of the interaction between the two magnets 422 and the coil unit 410 (from attraction to repulsion, or from repulsion to attraction), making it easier to control the direction of motion of the transmission shaft 421. By utilizing the principle of electromagnetic induction, precise control of the transmission shaft 421's movement can be achieved. By adjusting the current strength in the coil unit 410, the intensity of the magnetic field generated by the coil unit 410 can be controlled, thus controlling the magnitude of the attractive or repulsive force acting on the magnet 422. This reduces mechanical wear and enhances the reliability and lifespan of the electromagnetic drive mechanism 400, making it suitable for various applications requiring precise control.

It should be noted that, with reference to FIG. 1, in some embodiments of the present disclosure, the cross-sectional area of the second frame body 200 is larger than the cross-sectional area of the first frame body 100. In this embodiment, the first frame body 100 serves as a fixed frame, while the second frame body 200 serves as a movable frame. The second frame body 200 is connected to the massage body, which can be understood as a sofa cushion or a mattress, without limitation. The second frame body 200 is covered over the first frame body 100, and through the electromagnetic drive mechanism 400 and the guide mechanism 300, the second frame body 200 moves back and forth relative to the first frame body 100 in a reciprocating motion.

Specifically, in the embodiments of the present disclosure, the magnet 422 is a neodymium iron boron (NdFeB) magnet. The use of NdFeB magnets as the core material for the magnet 422 provides high remanence and coercivity, which enables the generation of a strong magnetic field with high magnetic strength. Furthermore, compared to other permanent magnetic materials, NdFeB magnets have a broader operational temperature range and can maintain good magnetic performance in high-temperature environments. NdFeB magnets also have a high magnetic energy product, which means that for identical magnetic performance, smaller and lighter magnets can be produced, thus helping to reduce the size and weight of the chassis assembly. Specifically, in this embodiment, the neodymium iron boron magnet is selected as an N52 high-magnetic neodymium iron boron magnet.

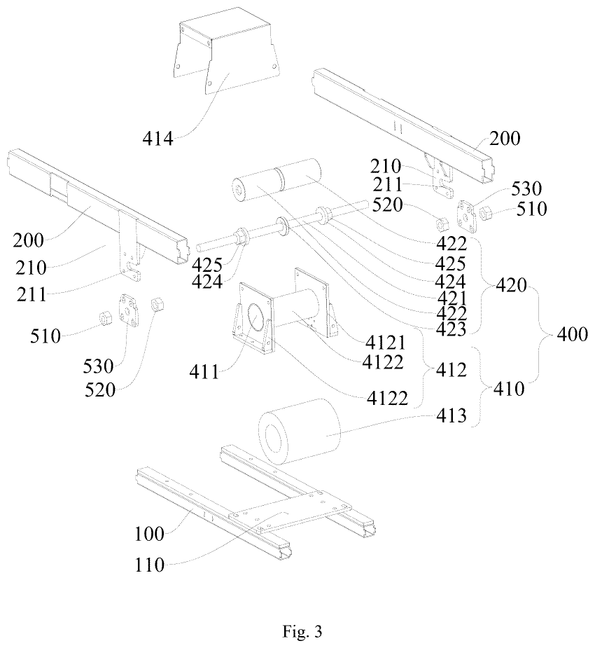

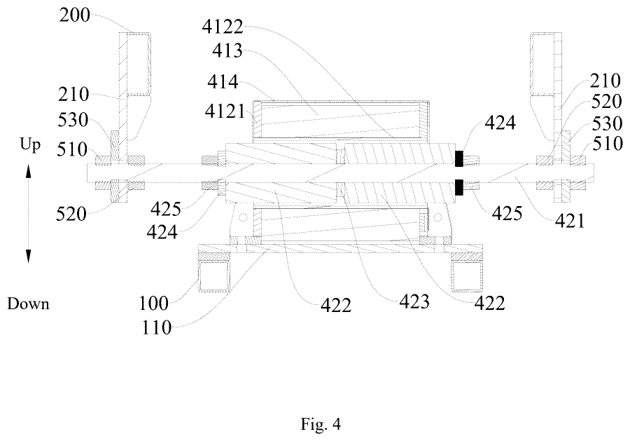

Specifically, referring to FIG. 3 and FIG. 4, in present embodiment, a gap denoted as L, is provided between the two magnets 422, where the value of L ranges from 2 mm to 10 mm. With the above structure, the two magnets 422 arranged at intervals help reduce mutual interference between them, thereby improving operational reliability.

Specifically, in the present embodiment, the value of L is 5 mm.

It can be understood that, referring to FIG. 3 and FIG. 4, in the embodiment of the present disclosure, the magnetic module 420 includes a separation sheet 423. The separation sheet 423 is disposed between the two magnets 422, with one end of the separation sheet 423 abutting one of the magnets 422 and the other end abutting the other magnet 422. By adopting the above structure, the presence of the separation sheet 423 can isolate the magnetic field transmission between the two magnets 422. Through reasonable design of the separation sheet 423, the magnetic field strength of the magnetic module 420 can be enhanced. The separation sheet 423 can serve to concentrate the magnetic field lines, making the magnetic field more focused and stronger, thereby achieving the intended magnetic field directional effect.

Specifically, with reference to FIGS. 3 and 4, in the present embodiment, the separation sheet 423 is a stainless-steel sheet mounted on the transmission shaft 421. The structure is simple, easy to assemble, and with a low manufacturing cost. It should be noted that, in present embodiment, the thickness of the stainless-steel sheet is 5 mm, which is suitable for the gap between the two magnets 422.

Of course, in some embodiments, the separation sheet 423 may also be made of a separation adhesive sheet or other materials, without being limited to the examples mentioned.

It can be understood that, with reference to FIG. 3 and FIG. 4, in the embodiments of the present disclosure, the magnetic module 420 further includes a positioning structure. The positioning structure is provided on the transmission shaft 421 and is used to restrict the relative movement of the two magnets 422 along the axis of the transmission shaft 421. By adopting the above structure, the arrangement of the positioning structure effectively limits the relative movement between the magnets 422 and the transmission shaft 421, thereby providing a stable magnetic force transmission. This ensures that the magnetic module 420 will not experience unintended displacement or misalignment during motion, thereby ensuring the reliability and stability of the electromagnetic drive mechanism.

Specifically, referring to FIG. 3 and FIG. 4, in this embodiment, the positioning structure includes two positioning washers 424 and two positioning components 425. The two positioning washers 424 are each sleeved onto the transmission shaft 421, and the two magnets 422 are positioned between the two positioning washers 424, with each positioning washer 424 making contact with a corresponding magnet 422. The two positioning components 425 are fixedly connected to the transmission shaft 421, and each positioning component 425 is in contact and engaged with a corresponding positioning washer 424 to restrict the relative movement of the positioning washers 424 along the axis of the transmission shaft 421. By using the positioning washers 424, a tight connection can be formed between the two magnets 422. The surface-to-surface contact between the positioning washers 424 and the adjacent magnets 422 increases the contact area, enabling a secure connection and preventing loosening. This, in turn, enhances the performance and reliability of the electromagnetic drive.

It should be noted that the positioning washers 424 may be made by metal or rubber etc., without limitation.

Specifically, in present embodiment, the transmission shaft 421 is a screw, and the positioning component 425 is a positioning nut, which is threadedly engaged with the threaded section of the transmission shaft 421. This structure is simple and facilitates disassembly and maintenance. Of course, in present embodiment, the positioning component 425 can also be a pin fixedly connected with the transmission shaft 421, or the positioning component 425 can be fixedly connected with the transmission shaft 421 by a clamping method, without limitation herein.

It should be understood that, in some embodiments, the magnet 422 may be fixed to the transmission shaft 421 using a screw, a clamping connection, or other suitable methods. The disclosure is not limited to these specific fastening techniques.

It can be understood that, in the present embodiment, both ends of the transmission shaft 421 corresponding to the second frame body 200 are provided with connecting plates 210. Each connecting plate 210 is provided with a connecting channel 211, and the connecting channel 211 has an opening. The end of the transmission shaft 421 moves along the opening and is fitted into the connecting channel 211. Furthermore, at each end of the transmission shaft 421, a fastening assembly is provided between the transmission shaft 421 and each connecting plate 210, and the fastening assembly is used to secure the transmission shaft 421 to the connecting plate 210.

With the above design, the connecting channel 211 on the connecting plate 210 provides an accurate positioning location, allowing the transmission shaft 421 to be accurately installed and fixed on the connecting plate 210. This helps ensure the correct alignment and fitting of the transmission shaft 421 with other components. The opening design of the connecting channel 211 facilitates the installation of the transmission shaft 421. By placing the end of the transmission shaft 421 into the connecting channel 211 along the opening, the assembly process can be completed quickly and easily. Furthermore, the fastening assembly is used to fix the transmission shaft 421 and the connecting plate 210 relative to each other, ensuring the firmness of the connection and preventing the transmission shaft 421 from accidentally loosening or falling off during use.

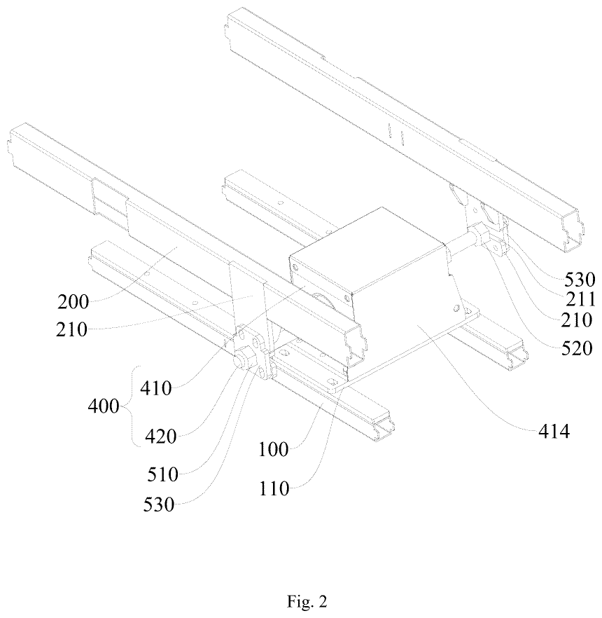

Specifically, referring to FIG. 2, FIG. 3, and FIG. 4, in the present embodiment, the fastening assembly comprising a first fastener 510, a second fastener 520, and a limiting plate 530. The first fastener 510 and the second fastener 520 are respectively positioned at opposite sides of the connecting plate 210. Each fastener is securely attached to the end portion of the transmission shaft 421. The limiting plate 530 is sleeved over the end portion of the transmission shaft 421 and is fixedly connected to the connecting plate 210. The outer diameter of the limiting plate 530 is larger than the inner diameter of the connecting channel 211. The first fastener 510 is located on the side surface of the connecting plate 210 facing away from the center of the transmission shaft 421, while the limiting plate 530 is positioned between the first fastener 510 and the connecting plate 210, where it abuts both the first fastener 510 and the connecting plate 210.

With the above structure, the first fastener 510 and the second fastener 520 are positioned on opposite sides of the connecting plate 210 and securely attached to the end portion of the transmission shaft 421, ensuring a stable connection between the connecting plate 210 and the transmission shaft 421. The outer diameter of the limiting plate 530 is larger than the inner diameter of the connecting channel 211, thereby restricting the movement of the transmission shaft 421 and preventing it from becoming detached or misaligned from the connecting plate 210, providing additional support and stability. The first fastener 510 is located on the side surface of the connecting plate 210 that faces away from the center of the transmission shaft 421, while the limiting plate 530 is positioned between the first fastener 510 and the connecting plate 210. The three components are in abutting contact, which enhances the connection strength and prevents loosening or detachment between the connecting plate 210 and the transmission shaft 421.

It should be noted that, in present embodiment, since the transmission shaft 421 is a screw, the first fastener 510 is a first fastening nut, and the second fastener 520 is a second fastening nut. This design is simple in structure and facilitates disassembly and maintenance. It should be noted that, in present embodiment, since the transmission shaft 421 is a screw rod, the first fastener 510 is a first fastening nut, and the second fastener 520 is a second fastening nut. This design is simple and facilitates assembly and maintenance.

It can be understood that, referring to FIGS. 2, 3, and 4, in the present embodiment, the coil unit 410 includes a mounting frame body 412 and a coil body 413. The mounting frame body 412 is connected to the first frame body 100, the motion channel 411 is provided on the mounting frame body 412, and the coil body 413 is arranged on the mounting frame body 412. With the above structure, the connection between the mounting frame body 412 and the first frame body 100 allows the coil unit 410 to be easily installed in the desired position, further enhancing the assembly stability of the coil body 413. Additionally, it facilitates the relative movement of the transmission shaft 421 within the motion channel 411. The structure is reasonable, enabling more flexible and stable motion and efficient transmission of magnetic force.

It should be noted that, in present embodiment, the mounting frame body 412 is a stainless-steel profiled framework. The design of using a stainless-steel profiled framework as the mounting frame body 412 provides strength, stability, and corrosion resistance, while also offering the advantages of lightweight construction and aesthetic appearance.

Specifically, with reference to FIGS. 2, 3, and 4, in the present embodiment, the mounting frame body 412 includes two supporting side plates 4121 and a supporting tube 4122. A bottom plate 110 is provided on the first frame body 100, and one end of each of the two supporting side plates 4121 is connected to the bottom plate 110. The two supporting side plates 4121 are arranged at intervals, and both ends of the supporting tube 4122 are connected to the two supporting side plates 4121. The supporting tube 4122 is hollow, forming the motion channel 411. The coil body 413 is wound around the supporting tube 4122. This structure is simple, easy to manufacture, and offers good stability.

Of course, in some embodiments, the mounting frame body 412 may also include a mounting base. By providing the motion channel 411 on the mounting base and winding the coil body 413 around the mounting base, no limitation is imposed.

Specifically, in present embodiment, the winding method for the coil body 413 is as follows:

First: Use a 0.9 mm diameter pure copper enameled wire with high-temperature-resistant over 220° C. to wind 1,220 turns. Leave a 25 cm long lead wire, then wind another 1,000 turns with identical 0.9 mm diameter pure copper enameled wire with high-temperature-resistant over 220° C. Leave another 25 cm long lead wire.

Second: Connect the starting ends of the wires together and the ending ends together. Solder the starting wire to a 1.5 mm diameter, 25 cm long black multi-strand plastic-coated wire for output, and solder the ending wire to a 1.5 mm diameter, 25 cm long red multi-strand plastic-coated wire for output. The resistance of the first layer is 6.1 ohms, the resistance of the second layer is 7.1 ohms, and the total resistance from the black wire to the red wire is between 3.3 ohms and 3.4 ohms.

It should be noted that, referring to FIGS. 2, 3, and 4, in the present embodiment, the electromagnetic driving mechanism 400 further includes a protective cover 414. The protective cover 414 is positioned over the coil unit 410, serving to provide protection and dust prevention.

It can be understood that, referring to FIG. 1, in the present embodiment, the electromagnetic driving mechanisms 400 are configured as multiple sets. These multiple sets of electromagnetic driving mechanisms 400 are arranged at intervals between the first frame body 100 and the second frame body 200. By arranging multiple sets of electromagnetic driving mechanisms 400 at intervals between the first frame body 100 and the second frame body 200, balanced force distribution and control can be achieved, preventing tilting or instability. This design reduces vibration and swaying of the entire chassis assembly, thereby improving operational stability. Furthermore, the interval arrangement of multiple sets of electromagnetic driving mechanisms 400 ensures more uniform and comprehensive force transmission. Each set of magnets 422 can exert force on the first frame body 100 and the second frame body 200, ensuring that the force is evenly distributed across the entire structure and enhancing the effectiveness of force transmission.

Specifically, referring to FIG. 1, in present embodiment, the electromagnetic driving mechanism 400 consists of four sets, arranged in two rows with two sets per row, spaced between the first frame body 100 and the second frame body 200. Of course, in some embodiments, the electromagnetic driving mechanism 400 may also comprising one set, two sets, three sets, five sets, eight sets, or other configurations, without limitation.

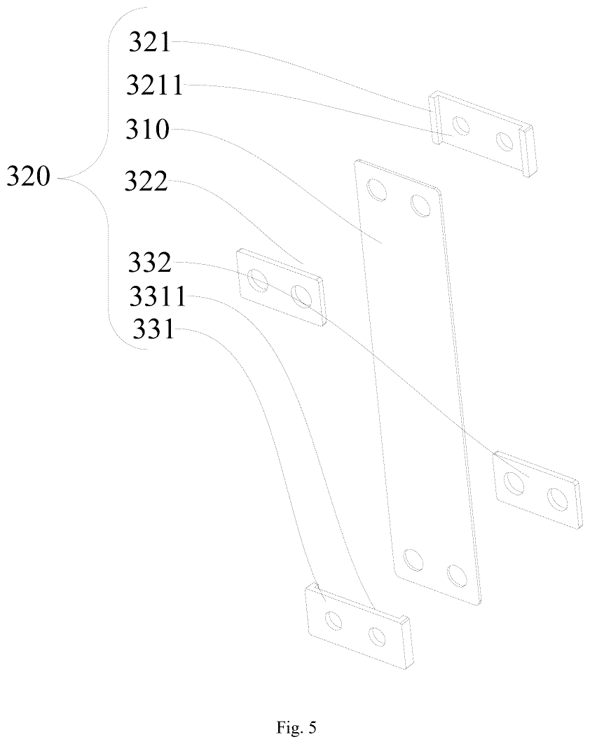

It can be understood that, with reference to FIG. 1 and FIG. 5, in some embodiments of the present disclosure, the guide mechanism 300 includes a guide elastic plate 310, a first fixing unit, and a second fixing unit. The first fixing unit comprising a first fixing member 321, a first pressing piece 322, and a first connecting structure. One end of the guide elastic plate 310 is clamped between the first fixing member 321 and the first pressing piece 322, and the guide elastic plate 310, the first fixing member 321, and the first pressing piece 322 are fixedly connected to the first frame body 100 through the first connecting structure; the second fixing unit comprising a second fixing member 331, a second pressing piece 332, and a second connecting structure. The other end of the guide elastic plate 310 is clamped between the second fixing member 331 and the second pressing piece 332, and the other end of the guide elastic plate 310, the second fixing member 331, and the second pressing piece 332 are fixedly connected to the second frame body 200 through the second connecting structure;

Wherein, the first fixing member 321 is provided with a first limiting concave surface 3211, and the second fixing member 331 is provided with a second limiting concave surface 3311. The widths of both the first limiting concave surface 3211 and the second limiting concave surface 3311 are adapted to the width of the guide elastic plate 310.

Through the above structure, the guide elastic plate 310 can follow the movement of the second frame body 200 and undergo elastic deformation. The deformation direction of the guide elastic plate 310 aligns with the movement direction of the second frame body 200. When the second frame body 200 moves relative to the first frame body 100, the force exerted by the second frame body 200 on the guide elastic plate 310 is perpendicular to the plate surface of the guide elastic plate 310. The structural design of the guide elastic plate 310 restricts the movement direction of the second frame body 200, which helps prevent the second frame body 200 from deviating from its intended movement direction, thereby avoiding shaking or instability during movement. This enhances the stability of the chassis assembly during operation and improves user comfort. Additionally, the structure is simple, cost-effective, and durable; furthermore, with the first limiting concave surface 3211 of the first fixing member 321 and the second limiting concave surface 3311 of the second fixing member 331, both surfaces are adapted to the width of the guide elastic plate 310. The first and second limiting concave surfaces 3211 and 3311 firmly abut the guide elastic plate 310, effectively preventing the guide elastic plate 310 from wobbling in its width direction relative to the first frame body and the second frame body 200, thus improving the overall structural stability.

Of course, the above guiding structure is not limited to the guiding direction of the guide elastic plate 310. In some embodiments, the guiding structure may also include a first guide seat, a second guide seat, and a ball. The first guide seat is connected to the first frame body 100, and the second guide seat is connected to the second frame body 200. A guiding channel is formed between the first guide seat and the second guide seat. The ball is rollable positioned within the guiding channel and is in contact with it.

It should be noted that the aforementioned first connecting structure and second connecting structure both include connecting bolts and connecting nuts, featuring a simple structure that facilitates assembly, disassembly, and maintenance.

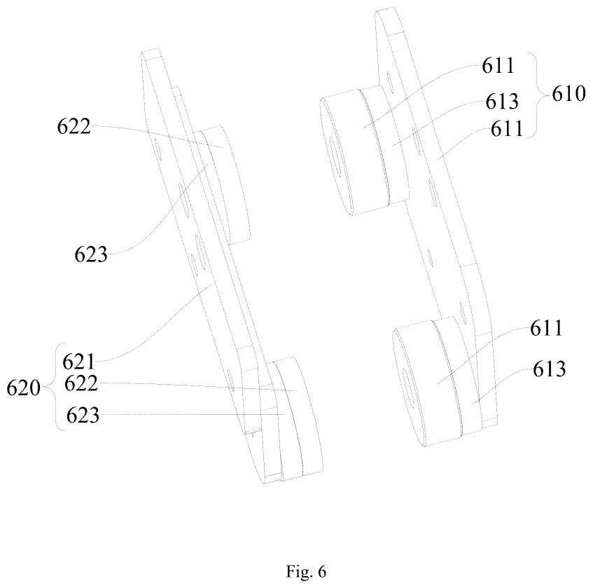

It is understood that, referring to FIG. 1 and FIG. 6, in some embodiments of the present application, both opposite ends of the first frame body 100 are provided with first magnetic modules 610, and both opposite ends of the second frame body 200 are provided with second magnetic modules 620. The first magnetic modules 610 and the second magnetic modules 620 are arranged correspondingly and spaced apart. The magnetic poles of the opposing ends of the first magnetic modules 610 and the second magnetic modules 620 are identical. With the above configuration, the relative movement between the first frame body 100 and the second frame body 200 can be ensured to occur within a specified range, avoiding movement beyond the defined limits. This guarantees the normal operation of the chassis assembly, prevents excessive force transmission between the first frame body 100 and the second frame body 200, and avoids abnormal movement or collision under unexpected circumstances. Consequently, the risks of overloading or damage are mitigated, extending the service life of the chassis assembly. Furthermore, this setup simplifies the operation process, reduces the technical requirements for operators, and enhances the convenience and reliability of operation; Additionally, when the distance between the first frame body 100 and the second frame body 200 reaches the limit value, due to the identical magnetic poles of the opposing ends of the first magnetic module 610 and the second magnetic module 620, the movement between the first frame body 100 and the second frame body 200 is obstructed, thus limiting further movement. The repulsive force generated by the identical polarities of the magnetic poles increases as the first frame body 100 or the second frame body 200 approaches the limiting position, creating a resistance force that causes the second frame body 200 to stop moving. This facilitates precise position control and ensures that the second frame body 200 halts at the desired position.

Specifically, in the present embodiment, the first magnetic module 610 and the second magnetic module 620 are arranged facing each other. The first magnetic module 610 includes a first mounting plate 611 and two first magnetic columns 612, with the two first magnetic columns 612 spaced apart and connected to the first mounting plate 611. The second magnetic module 620 includes a second mounting plate 621 and two second magnetic columns 622, with the two second magnetic columns 622 spaced apart and connected to the second mounting plate 621; Additionally, a first pad piece 613 is disposed between each first magnetic column 612 and the first mounting plate 611, and a second pad piece 623 is disposed between each second magnetic column 622 and the second mounting plate 621. This compact structure enhances the stability of the entire assembly.

Specifically, in some embodiments, the first pad piece 613 and the second pad piece 623 can be iron pads or rubber pads.

Of course, in some embodiments, the chassis assembly may further include a flexible rubber pad, which is disposed on the first frame body 100 or the second frame body 200 to prevent collision and wear.

It should be noted that, in the present embodiment, both the front side and the rear side of the first frame body 100 and the second frame body 200 are equipped with a set of first magnetic modules 610 and a set of second magnetic modules 620. Of course, the number of the aforementioned first magnetic modules 610 and second magnetic modules 620 can also vary, such as one set, two sets, three sets, or more, without being limited to the configuration described herein.

The working principle of the electromagnetic driven chassis assembly in the embodiments of the present disclosure is explained as follows:
The control switch outputs a control signal to the electromagnetic driving mechanism 400;
The sensor detects the relative position of the first frame body 100 and the second frame body 200 to obtain the oscillation position signal. The oscillation position signal is then transmitted to the driving device;
In the startup phase, according to the control signal, a driving voltage is applied to the coil unit 410. The current flows through the coil unit 410, generating a magnetic field that interacts with the magnetic module 420 to create a magnetic field variation. This causes the second frame body 200 of the chassis assembly to move from its initial amplitude to the target amplitude; Based on the motion position signal, when the movement position of the second frame body 200 reaches the preset position, the polarity of the driving voltage is adjusted, causing the second frame body 200 to oscillate back and forth in a reciprocating motion.

In the operation stage, the movement direction and amplitude of the second frame body 200 are determined based on the rhythm position signal. The absolute value of the driving voltage is adjusted according to the movement direction of the second frame body 200. Specifically, the absolute value of the driving voltage reaches its maximum when the second frame body 200 is at the middle position, and it reaches its minimum when the second frame body 200 is at either the first position (forward side limit position) or the second position (backward side limit position). The middle position corresponds to the minimum movement amplitude of the second frame body 200, while the first and second positions correspond to the target amplitude of the second frame body 200 in their respective movement directions. When the second frame body 200 reaches the target amplitude, the polarity of the driving voltage is adjusted, causing the second frame body 200 to oscillate back and forth between the first and second positions.

Finally, it should be noted that the above embodiments are only intended to illustrate the technical solutions of the present disclosure, and not to limit them. Although the present disclosure has been described in detail with reference to the aforementioned embodiments, those skilled in the art will understand that modifications can still be made to the technical solutions described in these embodiments, or some technical features can be equivalently replaced. These modifications or substitutions do not depart from the spirit and scope of the technical solutions of the embodiments of the present disclosure.

What is claimed is:

1. An electromagnetically driven chassis assembly, comprising:
a first frame body (100);
a second frame body (200), wherein the second frame body (200) and the first frame body (100) are configured to move relative to each other;
a guide mechanism (300) disposed between the first frame body (100) and the second frame body (200), the guide mechanism (300) being configured to guide relative movement between the first frame body (100) and the second frame body (200); and
an electromagnetic driving mechanism (400), wherein the electromagnetic driving mechanism (400) comprising a coil unit (410) and a magnetic module (420), the first frame body (100) being connected to the coil unit (410), the second frame body (200) being connected to the magnetic module (420), and magnetic force being generated between the coil unit (410) and the magnetic module (420) through changes in magnetic field to enable relative movement between the first frame body (100) and the second frame body (200);
wherein the coil unit (410) is provided with a motion channel (411), the magnetic module (420) comprising a transmission shaft (421) and two magnets (422), an end portion of the transmission shaft (421) is connected to the second frame body (200), the transmission shaft (421) movably extends through the motion channel (411), the two magnets (422) are disposed on the transmission shaft (421), the two magnets (422) each extend at least partially into the motion channel (411), and the magnetic poles at opposite ends of the two magnets (422) are identical.

2. The electromagnetically driven chassis assembly according to claim 1, wherein a gap denoted as L, is provided between the two magnets (422), with L ranging from 2 mm to 10 mm.

3. The electromagnetically driven chassis assembly according to claim 2, wherein:
the magnetic module (420) comprising a separation sheet (423), the separation sheet (423) being disposed between the two magnets (422), one end of the separation sheet (423) abuts against one of the two magnets (422), and another end of the separation sheet (423) abuts against other one of the two magnets (422).

4. The electromagnetically driven chassis assembly according to claim 1, wherein the magnetic module (420) further comprising a positioning structure disposed on the transmission shaft (421), and the positioning structure being configured to restrict the movement of the two magnets (422) along an axis of the transmission shaft (421).

5. The electromagnetically driven chassis assembly according to claim 4, wherein the positioning structure comprising:
two positioning washers (424) sleeved onto the transmission shaft (421), with the two magnets (422) positioned between the two positioning washers (424), and each of the two positioning washers (424) is in a one-to-one abutting connection with a corresponding magnet (422);
two positioning components (425) fixedly connected to the transmission shaft (421), wherein each of the two positioning components (425) is in a one-to-one abutting fit with a corresponding positioning washer (424), thereby restricting movement of the two positioning washers (424) relative to the axis of the transmission shaft (421).

6. The electromagnetic drive chassis assembly according to claim 1, wherein connecting plates (210) are disposed at both ends of the second frame (200) corresponding to the transmission shafts (421), the connecting plates (210) being provided with connecting channels (211) including openings, and ends of the transmission shaft (421) are configured to move along the openings and engage in a plug-in fit with the connecting channels (211);
wherein a fastening assembly is provided between each end of the transmission shaft (421) and each of the connecting plates (210), and the fastening assembly being configured to secure the transmission shaft (421) to the connecting plates (210).

7. The electromagnetic drive chassis assembly according to claim 6, wherein the fastening assembly comprising a first fastener (510), a second fastener (520), and a limiting plate (530), the first fastener (510) and the second fastener (520) being positioned on opposite sides of each of the connecting plates (210) and each being fixedly connected to an end of the transmission shaft (421); wherein the limiting plate (530) is sleeved onto the end of the transmission shaft (421), fixedly connected to the connecting plate (210), and has an outer diameter larger than an inner diameter of each of the connecting channels (211);
the first fastener (510) is positioned on a side of each of the connecting plates (210) facing away from a middle of the transmission shaft (421), and the limiting plate (530) is located between the first fastener (510) and one of the connecting plates (210) and abuts against the first fastener (510), the second fastener (520), and the one of the connecting plates (210).

8. The electromagnetically driven chassis assembly according to claim 1, wherein,
the coil unit (410) comprising:
a mounting frame body (412), wherein the mounting frame body (412) is connected to the first frame body (100), and a motion channel (411) is formed in the mounting frame body (412); and
a coil body (413), wherein the coil body (413) is mounted on the mounting frame body (412).

9. The electromagnetically driven chassis assembly according to claim 8, wherein the mounting frame body (412) is a stainless-steel profiled frame.

10. The electromagnetically driven chassis assembly according to claim 1, wherein multiple sets of electromagnetic driving mechanisms (400) are provided, and the multiple sets of electromagnets driving mechanisms (400) are arranged at intervals between the first frame body (100) and the second frame body (200).

11. The electromagnetically driven chassis assembly according to claim 1, wherein the guide mechanism (300) comprising:
a guide elastic plate (310);
a first fixing unit comprising: a first fixing member (321), a first pressing piece (322), and a first connecting structure, wherein one end of the guide elastic plate (310) is clamped between the first fixing member (321) and the first pressing piece (322), and the first fixing member (321), the first pressing piece (322), and one end of the guide elastic plate (310) are fixedly connected to the first frame body (100) through the first connecting structure; and
a second fixing unit comprising: a second fixing member (331), a second pressing piece (332), and a second connecting structure, wherein the other end of the guide elastic plate (310) is clamped between the second fixing member (331) and the second pressing piece (332), and the second fixing member (331), the second pressing piece (332), and the other end of the guide elastic plate (310) are fixedly connected to the second frame body (200) through the second connecting structure;
wherein the first fixing member (321) is provided with a first limiting concave surface (3211), and the second fixing member (331) is provided with a second limiting concave surface (3311), wherein widths of the first limiting concave surface (3211) and the second limiting concave surface (3311) are matched with a width of the guide elastic plate (310).

12. The electromagnetically driven chassis assembly according to claim 1, wherein opposite ends of the first frame body (100) are provided with first magnetic modules (610), opposite ends of the second frame body (200) are provided with second magnetic modules (620), and the first magnetic modules (610) and the second magnetic modules (620) are arranged in a one-to-one correspondence and at intervals;
wherein poles at the opposite ends of the first magnetic module (610) and the second magnetic module (620) are identical.

13. A rhythmic furniture comprising the electromagnetically driven chassis assembly as claimed in claim 1.
